(19) United States
(12) Patent Application Publication
(10) Pub. No.: US 2025/0021317 A1
(43) Pub. Date: Jan. 16, 2025

(54) SYSTEMS AND METHODS FOR PARALLELIZING LOOPS THAT HAVE LOOP-DEPENDENT VARIABLES

(71) Applicant: Micron Technology, Inc., Boise, ID (US)

(72) Inventors: Bashar Romanous, Allen, TX (US); Skyler Arron Windh, McKinney, TX (US); Patrick Estep, Rowlett, TX (US)

(21) Appl. No.: 18/768,477

(22) Filed: Jul. 10, 2024

Related U.S. Application Data
(60) Provisional application No. 63/526,505, filed on Jul. 13, 2023.

(51) Int. Cl. G06F 8/41

(52) U.S. Cl. CPC G06F 8/456; G06F 8/4452; G06F 8/452

(57) ABSTRACT

Devices and techniques for parallelizing loops that have loop-dependent variables are described herein. A system includes a processing device; and a memory device configured to store instructions, which when executed by the processing device, cause the processing device to perform operations comprising: accessing, by a compiler executing on a processing device, a computer code listing; determining that the computer code listing includes a loop with a loop-carried dependency variable; optimizing the loop for parallel execution by removing the loop-carried dependency variable; and compiling the computer code listing into executable software code with the loop executable in parallel in hardware.

### PRIORITY APPLICATION

This application claims the benefit of priority to U.S. Provisional Application Ser. No. 63/526,505, filed Jul. 13, 2023, which is incorporated herein by reference in its entirety.

### BACKGROUND

Various computer architectures, such as the Von Neumann architecture, conventionally use a shared memory for data, a bus for accessing the shared memory, an arithmetic unit, and a program control unit. However, moving data between processors and memory can require significant time and energy, which in turn can constrain performance and capacity of computer systems. In view of these limitations, new computing architectures and devices are desired to advance computing performance beyond the practice of transistor scaling (i.e., Moore's Law).

Software execution may be multithreaded using multiple threads within a process, where each thread may execute independently but concurrently, while sharing process resources. Data may be communicated between threads using inter-thread communication methods. Additionally, execution of threads or processes may be coordinated.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

To easily identify the discussion of any particular element or act, the most significant digit or digits in a reference number refer to the figure number in which that element is first introduced.

FIG. 1 is a block diagram illustrating an architecture to load per-kernel configurations of a coarse-grained reconfigurable array (CGRA) processor, according to an embodiment.

FIG. 2 is a block diagram illustrating a method to configure a kernel for parallelizing a loop that has loop-carried dependencies, according to an embodiment.

FIG. 3 is a code listing of a loop with a variable having a loop-carried dependency, according to an embodiment.

FIG. 4 is a code listing of the loop of FIG. 3 with modified code to remove the loop-carried dependency, according to an embodiment.

FIG. 5 is a code listing with nested loops including a first loop and a second loop, where the nested loops include multiple loop-carried dependency variables, according to an embodiment.

FIG. 6 is a code listing with nested loops including a first loop and a second loop with substitute expressions to remove loop-carried dependency variables, according to an embodiment.

FIG. 7 is a flowchart illustrating an example method for parallelizing loops that have loop-dependent variables, in accordance with some embodiments.

FIG. 8 illustrates a block diagram of an example machine with which, in which, or by which any one or more of the techniques (e.g., methodologies) discussed herein can be implemented.

### DETAILED DESCRIPTION

Aspects of the present disclosure are directed to parallelizing loops for execution on a configurable hardware processor. A coarse-grained reconfigurable array (CGRA) processor includes an array of processing elements connected through a network where each processing element contains at least one arithmetic logic unit (ALU) (or similar functional unit) and a register file. The functional units are capable of executing arithmetic, logical, or memory operations. Each processing element is provided with an instruction specifying an operation. The processing elements may perform different memory functions such as read/write data from/to memory using a shared data and address bus. The processing elements are able to operate in parallel for high throughput.

A single task may be parallelized across several processing elements in a CGRA. Multiple tasks may involve multiple data streams. Tasks may be componentized into kernels (also referred to as “compute kernels”). A kernel is a routine compiled for high-throughput accelerators, such as a CGRA. Kernels are used by a main program, which typically runs on a central processing unit (CPU). Kernels may be used for popular functions, such as a fast Fourier transform (FFT), a 2D convolution, or a FIR filter. Kernels may be used to parallelize loops or other executable instructions.

A CGRA (or a portion of a CGRA) processor may be configured for kernel-based operations. A CGRA processor can be initialized to perform specific operations during execution of a kernel. Each kernel may require a different configuration of the CGRA processor to execute its particular algorithm. The configuration may configure the CGRA for computation and dataflow by and between processing elements. For example, one kernel may include one processing element in the array configured to pass its results to an adjacent processing element, while a different kernel may include passing the results between non-adjacent processing elements in the CGRA.

In some examples, a system is programmed to arrange components of a reconfigurable compute fabric (e.g., CGRA) into one or more synchronous flows. The reconfigurable compute fabric comprises one or more hardware dispatch interface controllers and one or more hardware compute/processing elements that can be arranged to form one or more synchronous flows.

A processing element comprises a processing element memory and a processor or other suitable logic circuitry forming a compute pipeline for processing received data. In some examples, a processing element comprises multiple parallel processing lanes, such as single instruction multiple data (SIMD) processing lanes. A processing element can further comprise circuitry for sending and receiving synchronous and asynchronous messages to dispatch interface controllers, other processing elements, and other system components, as described herein.

A dispatch interface controller can include a processor or other logic circuitry for managing synchronous flow, as described herein. The dispatch interface controller comprises circuitry for sending synchronous and asynchronous messages to processing elements, other dispatch interface controllers, and other system components, as described herein.

A synchronous flow can include or use hardware arranged in a reconfigurable compute fabric that comprises a hardware dispatch interface controller and an ordered synchronous data path comprising one or more hardware processing elements. A synchronous flow can execute one or more threads of work. To execute a thread, the hardware components of the synchronous flow pass synchronous messages and execute a predetermined set of operations in the order of the synchronous flow.

During operation, the CGRA processor executes instructions on several processing elements synchronously or concurrently. The processing may include execution of loops. A loop is a sequence of instructions that are continually repeated until a certain condition is reached. A CGRA can be used to execute loops in parallel by launching a hardware thread for each loop iteration and executing the thread in parallel.

For instance, a CGRA can run 64 hardware threads in parallel. A hardware thread can perform SIMD operations as well. If the CGRA data path is 512-bits, and the lane width is 32-bits, then each thread has 16 lanes and can perform 16 operations. As such, 64 hardware threads with SIMD enabled for 16 lanes would perform 1024 loop iterations in parallel. This parallelism can only be exploited if a loop has no loop-carried dependencies (also referred to as interloop dependencies). What is needed is an improved mechanism to identify loop-carried dependencies and replace them so that loops can be processed in parallel.

Loop-carried dependencies prevent a dataflow-based CGRA from using its hardware multithreading and SIMD capabilities to execute loop iterations in parallel. Without parallelization, the loop will be executed sequentially using a single hardware thread. SIMD is not applicable in that case. In some cases, loop-carried dependencies can be eliminated. The systems and techniques described herein enable a dataflow-based CGRA to execute loop iterations in parallel using hardware multithreading and SIMD operations; thus, yielding higher performance for the accelerated application.

The systems and techniques described herein eliminate loop-carried dependency variables by linking the change in the pattern of such dependency variables with the change of the pattern of another loop variable that is not a loop-carried dependency. Loop variables that do not have a loop-carried dependency can be the loop iterator or a global variable outside the loop (e.g., a variable that changes in an outer loop). This can be achieved by extracting a mask from a variable outside the loop body and applying the mask to the dependency variable using a logical/mathematical operator. Additional details are set forth below.

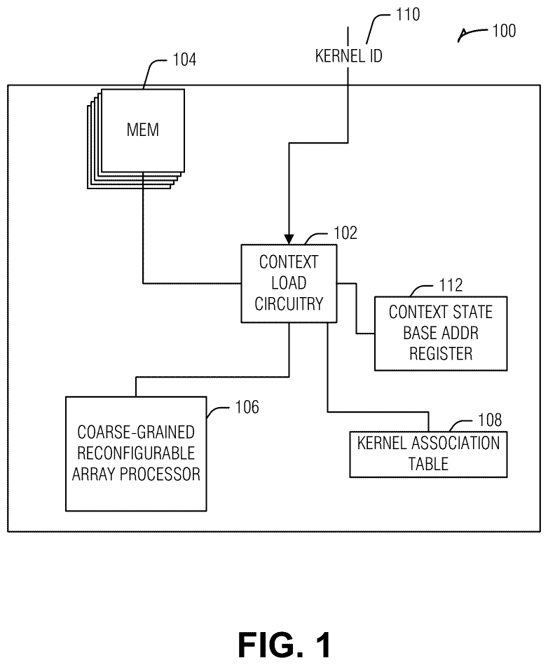

FIG. 1 is a block diagram illustrating an architecture 100 to load per-kernel configurations of a coarse-grained reconfigurable array (CGRA) processor, according to an embodiment. The architecture 100 illustrated in FIG. 1 includes context load circuitry 102, a memory device 104, and a CGRA processor 106. The memory device 104 may be main memory, such as host memory.

The context load circuitry 102 is used to identify the corresponding context data for a kernel. The context load circuitry 102 receives a kernel identifier signal 110. The kernel identifier signal 110 may be provided to the context load circuitry 102 by a host processor on the same node or from a different node.

The kernel identifier signal 110 may be an address offset that is associated with a kernel. In such an embodiment, each kernel may be mapped to a unique address offset. This address offset is then used to determine the corresponding context data.

The context load circuitry 102 adds the kernel identifier signal 110 to the context state base address (stored in the context state base address register 112) to obtain a context state address in the memory device 104 where the corresponding context state for the kernel is stored. This selected context state data is then used to program the CGRA processor 106 by storing the context state in one or more registers of corresponding processing elements in the CGRA processor 106.

In another embodiment, the kernel identifier signal 110 may be an identifier that is associated with a kernel. A kernel association table 108 is accessible by the context load circuitry 102. The kernel association table 108 may store associations between a kernel identifier and an address offset. This may be a one-to-one relationship (e.g., one kernel is associated with one and only one context) or a many-to-one relationship (e.g., multiple kernels identifiers are associated with the same context). Upon receiving the kernel identifier signal 110, the context load circuitry 102 performs a lookup in the kernel association table 108 and obtains an address offset. This address offset may then be used to determine the corresponding context state data, using the context state base address register 112, similar to how it is described above. The selected context state data is then used to program or configure the CGRA processor 106.

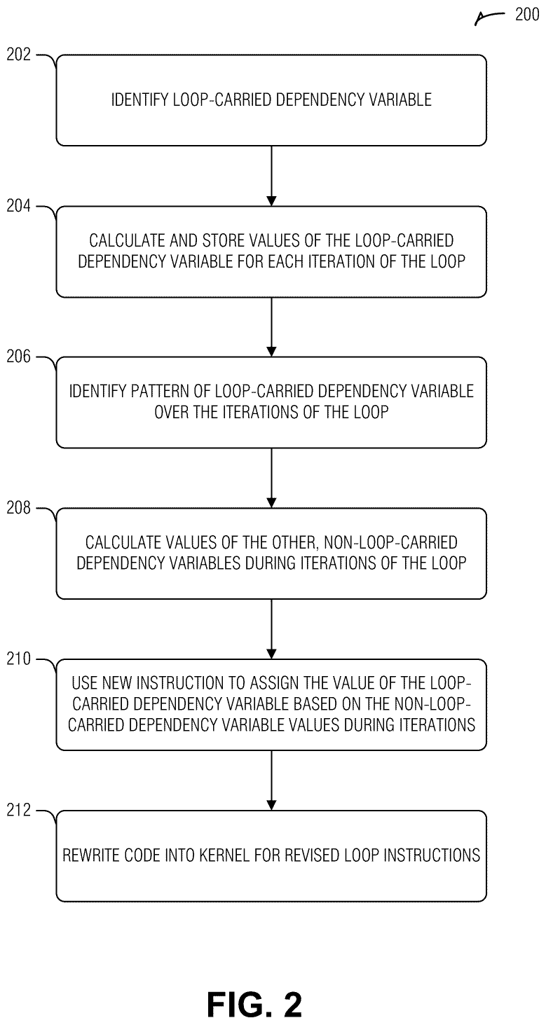

FIG. 2 is a block diagram illustrating a method 200 to configure a kernel for parallelizing a loop that has loop-carried dependencies, according to an embodiment. At 202, a loop-carried dependency variable is identified.

At 204, the values of the loop-carried dependency variable for each iteration of a loop is calculated and stored. In addition, the values of the loop iterator, outer-loop iterators (if any), and non-dependency variables that assign their value to or get assigned by the loop-carried dependency variable in question are identified and stored.

At 206, a pattern is identified, where the pattern exhibits a behavior of the loop-carried dependency variable over the iterations of the loop. The pattern may be observed through various mechanisms, such as trial and error, brute force, statistical techniques, use of a histogram, template matching, use of a neural network, or the like.

At 208, the values of non-loop-carried dependency variables for each loop iteration is calculated. This may be based on various logical or mathematical operations that can be applied to the value of a non-loop-carried dependency variable to produce the same value as the loop-carried dependency variable during a given loop iteration.

At 210, based on the discovered logical or mathematical operations, a new instruction is used to assign the value to the loop-carried dependency variable in question. The variable is no longer a loop-carried dependency variable because it does not rely on a value from a previous loop iteration.

At 212, the code for the loop is rewritten to use the new instruction and is saved as a kernel for parallel execution of the instructions in the loop.

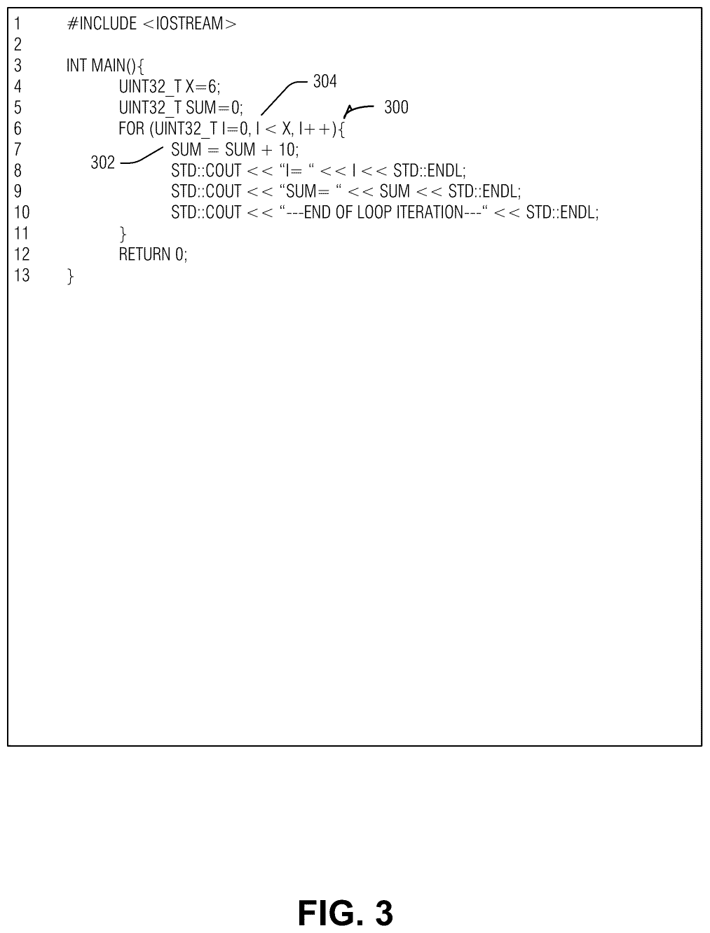

FIG. 3 is a code listing of a loop 300 with a variable having a loop-carried dependency, according to an embodiment. The loop 300 is a single loop (a loop having no nested loops) with a variable “sum” 302 that is being accumulated by increments of ten. Thus, the variable “sum” 302 is a loop-carried dependency because it is first defined outside the loop (e.g., instantiated and initialized at line 5) and then updated inside the loop at each iteration (e.g., revised in line 7). The variable “sum” 302 is modified in each iteration based on its value from the previous iteration.

Following the method 200 of FIG. 2, values of the loop-carried dependency variable for each iteration of the loop can be determined or calculated (e.g., operation 204). In the example of FIG. 3, the values of the loop-carried dependency variable can be determined to be [10, 20, 30, 40, 50, 60, 70]. There is an apparent pattern of a linear stepwise progression of ten units every iteration (e.g., operation 206). The values of the other variables that are non-loop-carried dependency variables are calculated (e.g., operation 208). Here, the only other variable of interest is “i” 304, the loop counter variable. The loop counter variable “i” 304 has an initial value of zero and increments by one in each loop iteration; its values over the whole loop execution are [0, 1, 2, 3, 4, 5, 6]. A new instruction can be used to assign the value of “sum” 302 at any given loop iteration step “i” 304 (e.g., operation 210), using the formula:

$$sum = 10 + ( i * 10 )$$

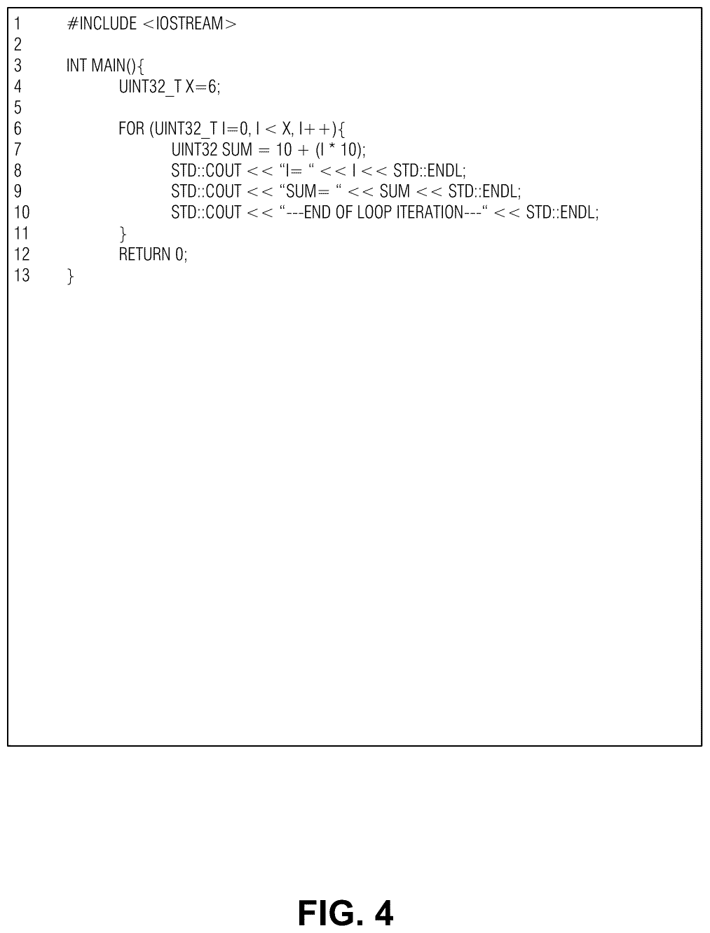

This formula is used in place of the previous operation (e.g., operation 212), and effectively removes the loop-carried dependency. The variable “sum” is no longer based on its value from the previous iteration. The revised loop 400 has no loop-carried dependencies and now each iteration can execute in parallel on a capable hardware (e.g., a CGRA). FIG. 4 is a code listing of the loop 400, which is loop 300 of FIG. 3 with modified code to remove the loop-carried dependency, according to an embodiment. In particular, replacing the code for loop 300 at line 7 removes loop-carried dependencies and can be executed with the loop counter variable alone. A properly configured compiler is able to create instructions that can be executed in parallel and asynchronously.

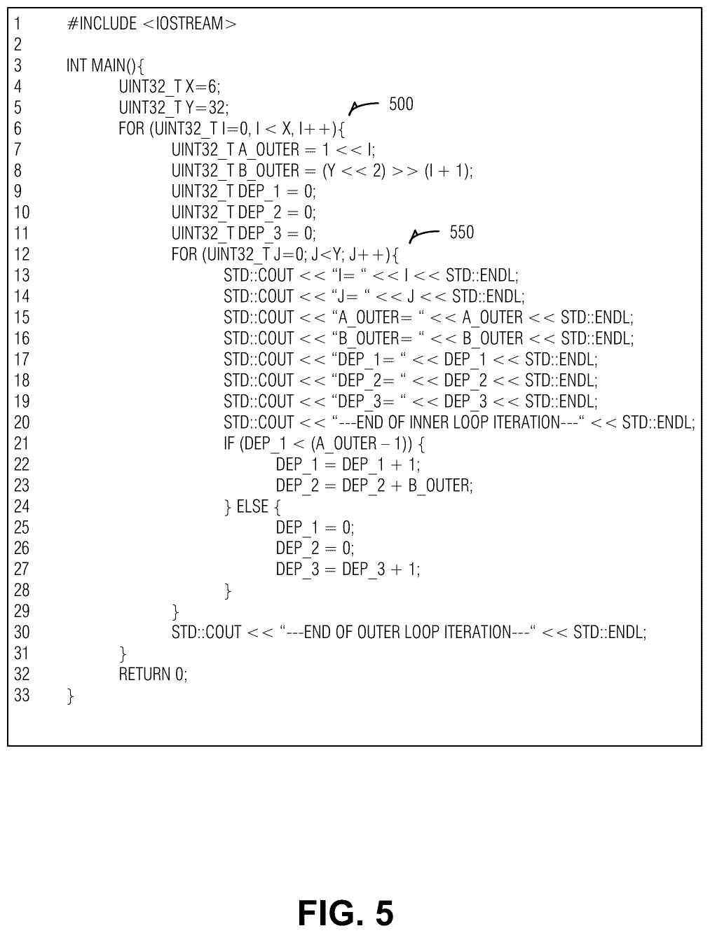

FIG. 5 is a code listing with nested loops including loop 500 and loop 550, where the nested loops include multiple loop-carried dependency variables, according to an embodiment. The outer loop 500 executes X iterations using loop iterator “i”, while the inner loop 550 executes Y iterations using loop iterator “j”. Running the inner loop 550 iterations in parallel would significantly accelerate the throughput of this program. However, there are three loop-carried dependency variables preventing such acceleration: dep_1, dep_2, and dep_3.

The method 200 can be applied independently to each loop-carried dependency variable. If all of the loop-carried dependency variables can be resolved, then the inner loop 550 can be executed in parallel with the outer loop 500.

As similarly described above, values of dep_1 over the iterations of the outer loop 500 and inner loop 550, along with any non-loop-carried dependent variables, such as loop counters “i” and “j”, can be analyzed. By calculating the values of “i”, “j”, and “dep_1” for each loop iteration, the following patterns are recorded:
1) When i=0, dep_1=0 for all values of j.
2) When i=1, dep_1=0 when j=[0, 2, 4, . . . ], and
   dep_1=1 when j=[1,3,5, . . . ].
3) When i=2, dep_1=0 when j=[0, 4, 8, . . . ],
   dep_1=1 when j=[1, 5,9, . . . ],
   dep_1=2 when j=[2, 6, 10, . . . ],
   dep_1=3 when j=[3,7, 11, . . . ].
Etc.

A pattern can be identified. For example, when i=0, dep_1 is always 0.When i=1, dep_1 alternates as 1 bit between [0,1]. When i=2, dep_1 alternates as 2 bits between [0,3]. This link or relationship between the variable dep_1 and i can be utilized to provide a value for dep_1 based on the inner loop counter “j” and a mask value. Assuming that “j” is a 5-bit field, it can be utilized to provide a value for dep_1 based on the mask.
For a mask=0b0, dep_1=(j & mask)=0
For a mask=0b1, dep_1=(j & mask)=[0,1]
For a mask=0b11, dep_1=(j & mask)=[0, 3]

Note that the mask value changes for each loop iteration. In an example, the mask value can be set based on the outer loop counter “i”, such that: uint32_t mask=0x0000001>>(5-i);

In this example, the operation “>>” is a right bit shift. Thus, the mask value is:
mask=0x0000 for i=0,
mask=0x0001 for i=1,
mask=0x0003 for i=2,
mask=0x0007 for i=3,
mask=0x000F for i=4,
mask=0x001F for i=5.

So, for the inner loop, we can replace lines 21, 22, and 25 of the code with non-loop-carried dependency statements:
uint32_t dep_1=j & mask;

where the operation “&” is a bitwise AND operation. Here the mask is defined in the outer loop 500 as:
uint32_t mask=0x0000001F >> (5-i);

This code works with Y=32, because “Y-1”=0x0000001F and log2(Y)=5. For a generic code snippet, the inner loop threshold “Y” can be used to control the outer loop-based mask, such that:
uint32_t mask=(Y-1) 22 >((uint32_t)log2(Y)-i);

Therefore, when:
i=0, mask=0b0, dep_1=
i=1, mask=0b1, dep_1=[0,1]
i=2, mask=0b11, dep_1=[0, 3]
Etc.

Turning to the variable dep_2, similar operations can be performed to remove this variable as a loop-carried dependency variable. As seen in the code example, the variable dep_2 is aggregated with variable “B_outer”, which is a variable that is dependent on the outer loop counter variable “i” and the inner loop threshold “Y”.

However, by inspecting the values, of “dep_2” and “B_outer”, a pattern can be identified:
1) When i=0, dep_2=0 for all j
2) When i=0, dep_2=0 for j=[0, 2, 4, . . . ],
   dep_2=1 * B_outer when j=[1, 3, 5, . . . ]
3) When i=2, dep_2=0 when j=[0, 4, 8, . . . ],
   dep_2=1 * B_outer for j=[1, 5, 9, . . . ],
   dep_2=2 * B_outer for j=[2, 6, 10, . . . ],
   dep_2=3 * B_outer for j=[3,7, 11, . . . ]
4) Etc.

Therefore, instead of accumulating “dep_2” using its value from the previous iteration, it can be expressed as:
uint32_t dep_2=dep_1 * B_outer;

Using this expression instead of the original code removes the loop-carried dependency on the previous value of dep_2 and the loop iterations can be calculated in parallel.

Turning to variable “dep_3”, which is also a loop-carried dependency variable, the process from above can be similarly applied to attempt to remove its dependency. As observed in the code at line 27, the value of dep_3 changes in certain conditions and used the previous value of dep_3 in its change of value. For example, the following pattern can be identified:
When i=0, dep_3=j for all values of j
When i=1, dep_3=0 for j=[0, 1]
   dep_3=1 for j=[2, 3]
   dep_3=2 for j=[4, 5]
When i=2, dep_3=0 for j=[0, 1, 2, 3]
   dep_3=1 for j=[4, 5, 6, 7]
   dep_3=2 for j=[8, 9, 10, 1]
   dep_3=3 for j=[12, 13, 14, 15]
Etc.

In other words, “dep_3” changes with the inner loop counter “j”, but at a slower rate. If bits of “j” are shifted to the right by the outer loop counter “i” positions, then the result is the value of “dep_3”. Therefore, “dep_3” can be expressed as:
uint32_t dep_3=j>>i;

It is understood that the substitute expressions found for dep_1, dep_2, and dep_3 are merely illustrative and that other substitute functions may be used to map from a domain to a range in an equivalent manner.

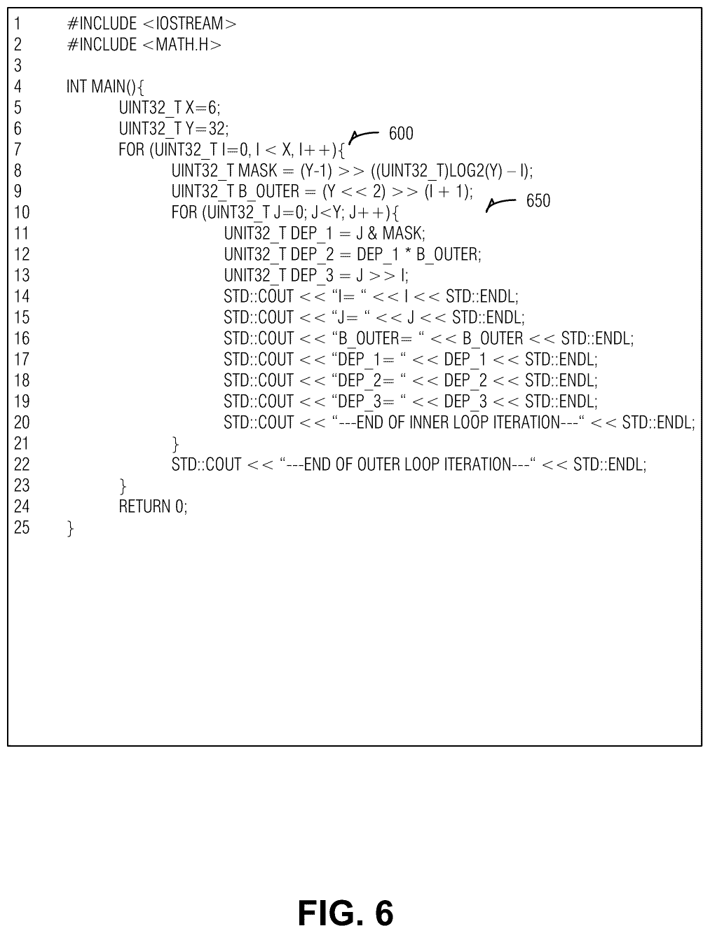

FIG. 6 is a code listing with nested loops including loop 600 and loop 650 with substitute expressions to remove loop-carried dependency variables from the example code of FIG. 5, according to an embodiment. After the code is revised with the substitute expressions, loops in the code can be executed in parallel. In an example, a kernel that comprises or defines the loops can be compiled to execute on multiple processing elements in a CGRA in parallel.

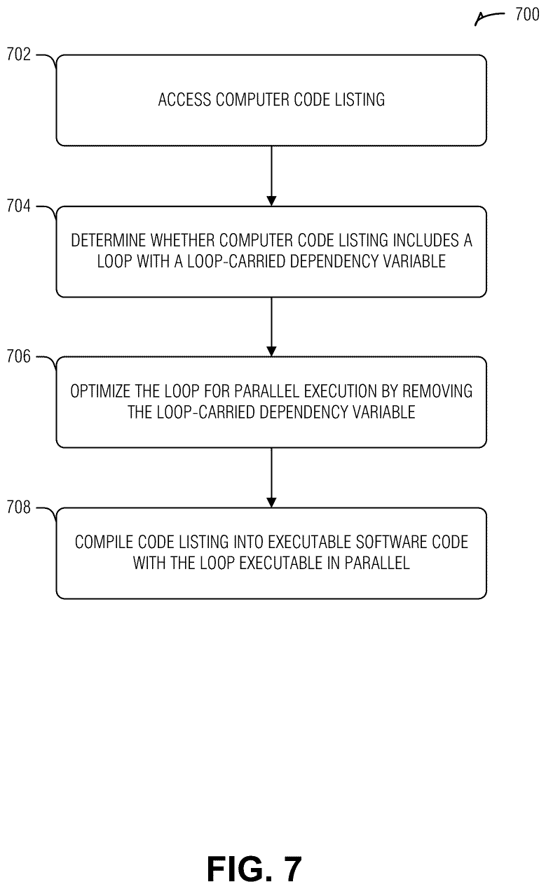

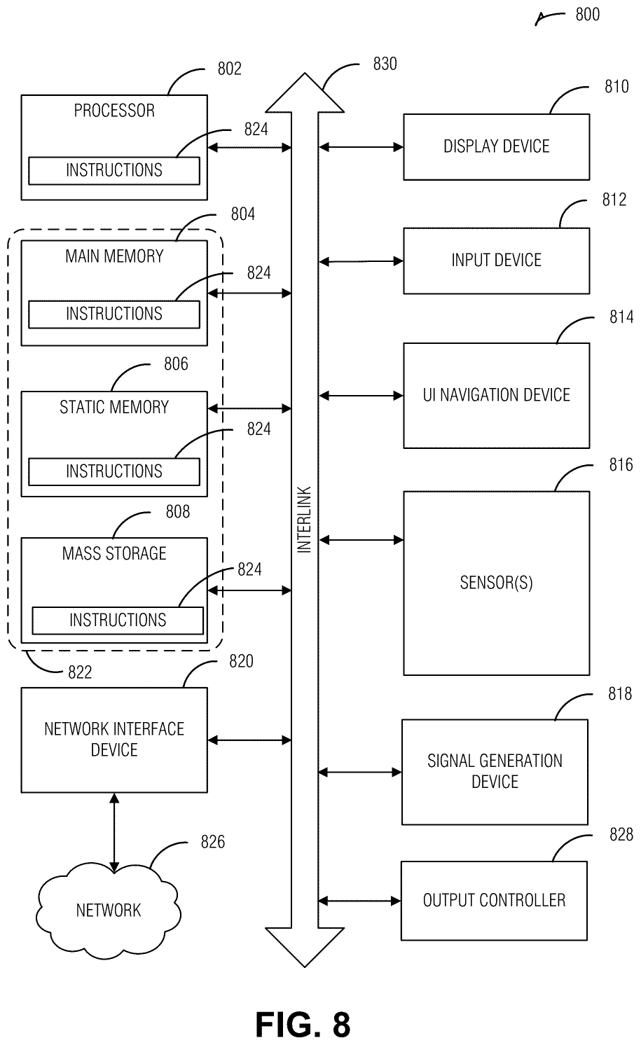

FIG. 7 is a flowchart illustrating an example method 700 for parallelizing loops that have loop-dependent variables, in accordance with some embodiments. The method 700 can be performed by processing logic that can include hardware (e.g., processing device, circuitry, dedicated logic, programmable logic, microcode, hardware of a device, integrated circuit, etc.). In some embodiments, the method 700 is performed by the hardware processor 802 of FIG. 8.

At operation 702, a compiler executing on a processing device (e.g., hardware processor 802) accesses a computer code listing.

At operation 704, the compiler determines whether the computer code listing includes a loop with a loop-carried dependency variable.

At operation 706, the compiler optimizes the loop for parallel execution by removing the loop-carried dependency variable.

In an embodiment, to optimize the loop for parallel execution, the compiler identifies the loop-carried dependency variable, calculates values of the loop-carried dependency variable for multiple iterations of the loop, and calculates values for other variables, including a loop iterator value, existing outer-loop iterators, and non-loop-carried dependency variables that have values calculated based on the loop-carried dependency variable. These other values are used to identify a pattern, where the pattern exhibits a behavior of the loop-carried dependency variable over the multiple iterations of the loop. The values of non-loop-carried dependency variables for corresponding loop iterations is calculated to produce the same value as the loop-carried dependency variable during a given loop iteration. Using the pattern, a new operation is identified to assign the value of the loop-carried dependency variable to a non-loop-carried dependency variable. The new operation is used in place of other operations that used the loop-carried dependency variable.

In an embodiment, the new operation comprises a bit shift operation. In a related embodiment, the new operation comprises a linear algebraic operation. In a related embodiment, calculating values of the loop-carried dependency variable for multiple iterations of the loop includes calculating values of the loop-carried dependency variable for every iteration of the loop.

If there are multiple optional operations to remove a loop-carried dependency, then the options may be evaluated and a more efficient or optimal operation may be selected. The options may be compared based on a cost function.

At operation 708, the compiler compiles the computer code listing into executable software code with the loop executable in parallel in hardware. In an embodiment, compiling the computer code listing includes compiling the computer code listing to be executable in parallel, at least in part, on a coarse-grained reconfigurable array (CGRA) processor.

In a further embodiment, the CGRA processor comprises a hardware dispatch interface controller and a plurality of hardware processing elements that are arranged into a synchronous flow. In a further embodiment, the dispatch interface controller includes a processing circuitry for managing synchronous flow. In another embodiment, a hardware processing element comprises a compute pipeline for processing data. In a related embodiment, the synchronous flow is used to execute a plurality of work threads in parallel, and the dispatch controller and the plurality of hardware processing elements pass messages to execute a predetermined set of operations in the order of the synchronous flow.

Although shown in a particular sequence or order, unless otherwise specified, the order of the methods or processes described herein can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

FIG. 8 illustrates a block diagram of an example machine 800 with which, in which, or by which any one or more of the techniques (e.g., methodologies) discussed herein can be implemented. Examples, as described herein, can include, or can operate by, logic or a number of components, or mechanisms in the machine 800. Circuitry (e.g., processing circuitry) is a collection of circuits implemented in tangible entities of the machine 800 that include hardware (c.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (c.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time. Additional examples of these components with respect to the machine 800.

In alternative embodiments, the machine 800 can operate as a standalone device or can be connected (e.g., networked) to other machines. In a networked deployment, the machine 800 can operate in the capacity of a server machine, a client machine, or both in server-client network environments. In an example, the machine 800 can act as a peer machine in peer-to-peer (P2P) (or other distributed) network environment. The machine 800 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 800 (e.g., computer system) can include a hardware processor 802 (e.g., a central processing unit (CPU), a graphics processing unit (GPU), a hardware processor core, or any combination thereof), a main memory 804, a static memory 806 (e.g., memory or storage for firmware, microcode, a basic-input-output (BIOS), unified extensible firmware interface (UEFI), etc.), and mass storage device 808 (e.g., hard drives, tape drives, flash storage, or other block devices) some or all of which can communicate with each other via an interlink 830 (e.g., bus). The machine 800 can further include a display device 810, an alphanumeric input device 812 (e.g., a keyboard), and a user interface (UI) Navigation device 814 (e.g., a mouse). In an example, the display device 810, the input device 812, and the UI navigation device 814 can be a touch screen display. The machine 800 can additionally include a mass storage device 808 (e.g., a drive unit), a signal generation device 818 (e.g., a speaker), a network interface device 820, and one or more sensor(s) 816, such as a global positioning system (GPS) sensor, compass, accelerometer, or other sensor. The machine 800 can include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 802, the main memory 804, the static memory 806, or the mass storage device 808 can be, or include, a machine-readable media 822 on which is stored one or more sets of data structures or instructions 824 (e.g., software) embodying or used by any one or more of the techniques or functions described herein. The instructions 824 can also reside, completely or at least partially, within any of registers of the hardware processor 802, the main memory 804, the static memory 806, or the mass storage device 808 during execution thereof by the machine 800. In an example, one or any combination of the hardware processor 802, the main memory 804, the static memory 806, or the mass storage device 808 can constitute the machine-readable media 822. While the machine-readable media 822 is illustrated as a single medium, the term “machine-readable medium” can include a single medium or multiple media (e.g., a centralized or distributed database, or associated caches and servers) configured to store the one or more instructions 824.

The term “machine readable medium” can include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable media 822 can be representative of the instructions 824, such as instructions 824 themselves or a format from which the instructions 824 can be derived. This format from which the instructions 824 can be derived can include source code, encoded instructions (e.g., in compressed or encrypted form), packaged instructions (e.g., split into multiple packages), or the like. The information representative of the instructions 824 in the machine-readable media 822 can be processed by processing circuitry into the instructions to implement any of the operations discussed herein. For example, deriving the instructions 824 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 824.

In an example, the derivation of the instructions 824 can include assembly, compilation, or interpretation of the information (e.g., by the processing circuitry) to create the instructions 824 from some intermediate or preprocessed format provided by the machine-readable media 822. The information, when provided in multiple parts, can be combined, unpacked, and modified to create the instructions 824. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 824 can be further transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 can include one or more physical jacks (e.g., Ethernet, coaxial, or phone jacks) or one or more antennas to connect to the network 826. In an example, the network interface device 820 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software. A transmission medium is a machine readable medium.

To better illustrate the methods and apparatuses described herein, a non-limiting set of Example embodiments are set forth below as numerically identified Examples.

Example 1 is a system comprising: a processing device; and a memory device configured to store instructions, which when executed by the processing device, cause the processing device to perform operations comprising: accessing, by a compiler executing on a processing device, a computer code listing; determining that the computer code listing includes, a loop with a loop-carried dependency variable; optimizing the loop for parallel execution by removing the loop-carried dependency variable; and compiling the computer code listing into executable software code with the loop executable in parallel in hardware.

In Example 2, the subject matter of Example 1 includes, wherein optimizing the loop comprises: identifying the loop-carried dependency variable; calculating values of the loop-carried dependency variable for multiple iterations of the loop; calculating values for other variables for each iteration of the loop, including a loop iterator value, existing outer-loop iterators, and non-loop-carried dependency variables that have values calculated based on the loop-carried dependency variable; identifying a pattern based on the values of the other variables, where the pattern exhibits a behavior of the loop-carried dependency variable over the multiple iterations of the loop; calculating the values of non-loop-carried dependency variables for corresponding loop iterations to produce the same value as the loop-carried dependency variable during each iteration of the multiple iterations of the loop; identifying a new operation using a non-loop-carried dependency variable to assign the value of the loop-carried dependency variable for each iteration of the multiple iterations of the loop; and using the new operation in place of other operations that used the loop-carried dependency variable in the loop.

In Example 3, the subject matter of Example 2 includes, wherein the new operation comprises a bit shift operation.

In Example 4, the subject matter of Examples 2-3 includes, wherein the new operation comprises a linear algebraic operation.

In Example 5, the subject matter of Examples 2-4 includes, wherein calculating values of the loop-carried dependency variable for multiple iterations of the loop comprises calculating values of the loop-carried dependency variable for every iteration of the loop.

In Example 6, the subject matter of Examples 1-5 includes, wherein compiling the computer code listing comprises compiling the computer code listing to be executable in parallel, at least in part, on a coarse-grained reconfigurable array (CGRA) processor.

In Example 7, the subject matter of Example 6 includes, wherein the CGRA processor comprises a hardware dispatch interface controller and a plurality of hardware processing elements that are arranged into a synchronous flow.

In Example 8, the subject matter of Example 7 includes, wherein the dispatch interface controller includes a processing circuitry for managing synchronous flow.

In Example 9, the subject matter of Examples 7-8 includes, wherein a hardware processing element comprises a compute pipeline for processing data.

In Example 10, the subject matter of Examples 7-9 includes, wherein the synchronous flow is used to execute a plurality of work threads in parallel, and wherein the dispatch controller and the plurality of hardware processing elements pass messages to execute a predetermined set of operations in the order of the synchronous flow.

Example 11 is a method comprising: accessing, by a compiler executing on a processing device, a computer code listing; determining that the computer code listing includes, a loop with a loop-carried dependency variable; optimizing the loop for parallel execution by removing the loop-carried dependency variable; and compiling the computer code listing into executable software code with the loop executable in parallel in hardware.

In Example 12, the subject matter of Example 11 includes, wherein optimizing the loop comprises: identifying the loop-carried dependency variable; calculating values of the loop-carried dependency variable for multiple iterations of the loop; calculating values for other variables for each iteration of the loop, including a loop iterator value, existing outer-loop iterators, and non-loop-carried dependency variables that have values calculated based on the loop-carried dependency variable; identifying a pattern based on the values of the other variables, where the pattern exhibits a behavior of the loop-carried dependency variable over the multiple iterations of the loop; calculating the values of non-loop-carried dependency variables for corresponding loop iterations to produce the same value as the loop-carried dependency variable during each iteration of the multiple iterations of the loop; identifying a new operation using a non-loop-carried dependency variable to assign the value of the loop-carried dependency variable for each iteration of the multiple iterations of the loop; and using the new operation in place of other operations that used the loop-carried dependency variable in the loop.

In Example 13, the subject matter of Example 12 includes, wherein the new operation comprises a bit shift operation.

In Example 14, the subject matter of Examples 12-13 includes, wherein the new operation comprises a linear algebraic operation.

In Example 15, the subject matter of Examples 12-14 includes, wherein calculating values of the loop-carried dependency variable for multiple iterations of the loop comprises calculating values of the loop-carried dependency variable for every iteration of the loop.

In Example 16, the subject matter of Example 11 includes, wherein compiling the computer code listing comprises compiling the computer code listing to be executable in parallel, at least in part, on a coarse-grained reconfigurable array (CGRA) processor.

In Example 17, the subject matter of Example 16 includes, wherein the CGRA processor comprises a hardware dispatch interface controller and a plurality of hardware processing elements that are arranged into a synchronous flow.

In Example 18, the subject matter of Example 17 includes, wherein the dispatch interface controller includes a processing circuitry for managing synchronous flow.

In Example 19, the subject matter of Examples 17-18 includes, wherein a hardware processing element comprises a compute pipeline for processing data.

In Example 20, the subject matter of Examples 17-19 includes, wherein the synchronous flow is used to execute a plurality of work threads in parallel, and wherein the dispatch controller and the plurality of hardware processing elements pass messages to execute a predetermined set of operations in the order of the synchronous flow.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A system comprising:
a processing device; and
a memory device configured to store instructions, which when executed by the processing device, cause the processing device to perform operations comprising:
accessing, by a compiler executing on a processing device, a computer code listing;
determining that the computer code listing includes a loop with a loop-carried dependency variable;
optimizing the loop for parallel execution by removing the loop-carried dependency variable; and
compiling the computer code listing into executable software code with the loop executable in parallel in hardware.

2. The system of claim 1, wherein optimizing the loop comprises:
identifying the loop-carried dependency variable;
calculating values of the loop-carried dependency variable for multiple iterations of the loop;
calculating values for other variables for each iteration of the loop, including a loop iterator value, existing outer-loop iterators, and non-loop-carried dependency variables that have values calculated based on the loop-carried dependency variable;
identifying a pattern based on the values of the other variables, where the pattern exhibits a behavior of the loop-carried dependency variable over the multiple iterations of the loop;
calculating the values of non-loop-carried dependency variables for corresponding loop iterations to produce the same value as the loop-carried dependency variable during each iteration of the multiple iterations of the loop;
identifying a new operation using a non-loop-carried dependency variable to assign the value of the loop-carried dependency variable for each iteration of the multiple iterations of the loop; and
using the new operation in place of other operations that used the loop-carried dependency variable in the loop.

3. The system of claim 2, wherein the new operation comprises a bit shift operation.

4. The system of claim 2, wherein the new operation comprises a linear algebraic operation.

5. The system of claim 2, wherein calculating values of the loop-carried dependency variable for multiple iterations of the loop comprises calculating values of the loop-carried dependency variable for every iteration of the loop.

6. The system of claim 1, wherein compiling the computer code listing comprises compiling the computer code listing to be executable in parallel, at least in part, on a coarse-grained reconfigurable array (CGRA) processor.

7. The system of claim 6, wherein the CGRA processor comprises a hardware dispatch interface controller and a plurality of hardware processing elements that are arranged into a synchronous flow.

8. The system of claim 7, wherein the dispatch interface controller includes a processing circuitry for managing synchronous flow.

9. The system of claim 7, wherein a hardware processing element comprises a compute pipeline for processing data.

10. The system of claim 7, wherein the synchronous flow is used to execute a plurality of work threads in parallel, and wherein the dispatch controller and the plurality of hardware processing elements pass messages to execute a predetermined set of operations in the order of the synchronous flow.

11. A method comprising:
accessing, by a compiler executing on a processing device, a computer code listing;
determining that the computer code listing includes a loop with a loop-carried dependency variable;
optimizing the loop for parallel execution by removing the loop-carried dependency variable; and
compiling the computer code listing into executable software code with the loop executable in parallel in hardware.

12. The method of claim 11, wherein optimizing the loop comprises:
identifying the loop-carried dependency variable;
calculating values of the loop-carried dependency variable for multiple iterations of the loop;
calculating values for other variables for each iteration of the loop, including a loop iterator value, existing outer-loop iterators, and non-loop-carried dependency variables that have values calculated based on the loop-carried dependency variable;
identifying a pattern based on the values of the other variables, where the pattern exhibits a behavior of the loop-carried dependency variable over the multiple iterations of the loop;
calculating the values of non-loop-carried dependency variables for corresponding loop iterations to produce the same value as the loop-carried dependency variable during each iteration of the multiple iterations of the loop;
identifying a new operation using a non-loop-carried dependency variable to assign the value of the loop-carried dependency variable for each iteration of the multiple iterations of the loop; and
using the new operation in place of other operations that used the loop-carried dependency variable in the loop.

13. The method of claim 12, wherein the new operation comprises a bit shift operation.

14. The method of claim 12, wherein the new operation comprises a linear algebraic operation.

15. The method of claim 12, wherein calculating values of the loop-carried dependency variable for multiple iterations of the loop comprises calculating values of the loop-carried dependency variable for every iteration of the loop.

16. The method of claim 11, wherein compiling the computer code listing comprises compiling the computer code listing to be executable in parallel, at least in part, on a coarse-grained reconfigurable array (CGRA) processor.

17. The method of claim 16, wherein the CGRA processor comprises a hardware dispatch interface controller and a plurality of hardware processing elements that are arranged into a synchronous flow.

18. The method of claim 17, wherein the dispatch interface controller includes a processing circuitry for managing synchronous flow.

19. The method of claim 17, wherein a hardware processing element comprises a compute pipeline for processing data.

20. The method of claim 17, wherein the synchronous flow is used to execute a plurality of work threads in parallel, and wherein the dispatch controller and the plurality of hardware processing elements pass messages to execute a predetermined set of operations in the order of the synchronous flow.
